(19) United States
(12) Patent Application Publication
(10) Pub. No.: US 2007/0247497 A1
(43) Pub. Date: Oct. 25, 2007

(54) Ink supply systems and methods for inkjet printheads

(75) Inventors: Jeffery James Buchanan, Lexington, KY (US); Johnnie Coffey, Winchester, KY (US); Steven Robert Komplin, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International Inc.

(21) Appl. No.: 11/411,015

(22) Filed: Apr. 25, 2006

(51) Int. Cl. B41J 2/175

(52) U.S. Cl. 347/85

(57) ABSTRACT

An ink container is provides ink to a vented printhead, where both the ink container and the vented printhead are positioned on a moveable carriage. The ink container receives ink from an off-carriage ink supply via an ink conduit. Air is removed from the printhead and ink container via a vacuum pump, coupled to an upper portion of the ink container via an air conduit. The vacuum pump is operable to pull air from the ink container by generating negative pressure in the ink container.

### FIELD OF THE INVENTION

The present invention relates generally to inkjet printers, and more specifically, to devices, methods, and systems for supplying ink to inkjet printer printheads.

### BACKGROUND OF THE INVENTION

Ink jet printers are used commonly in offices and home printing applications. They are popular due to their low cost of operation, low energy use and quiet operating features. Ink jet printing involves the ejection of tiny ink droplets through small holes, in a controlled manner, to create the desired image on the media intended to receive the image. Ink is supplied from an ink reservoir to a printhead, which includes various passageways from the reservoir to a plurality of firing chambers having nozzle orifices. Energy is applied to the ink from an ink droplet generator near each orifice, which may include the application of electrostatic attraction, the application of oscillating forces from piezo elements, the application of heat from heating elements or the like.

It is known to provide the nozzle orifices in a printhead cartridge that is mounted on a carriage that may support one or more such printheads. The carriage traverses back and forth across the medium being printed, and ink droplets are emitted as the carriage moves. One of the ways in which ink jet printing can be made faster is simply to move the carriage faster as the ink droplets are emitted. In doing so, it is desirable to minimize the amount of ink contained within the cartridge carried on the carriage, to reduce the weight and thus the momentum of the carriage. Further, the repeated and abrupt reversal in movement direction of the carriage traversing back and forth across the media can create turbulence in the ink, which in turn can cause printing problems due to air absorption, ink foaming and the like.

For some large printing devices, such as plotters used to create drawings, posters or other large printing jobs; or for printers such as color printers and printers designed for high volume print service utilizing large volumes of ink in relatively short time periods, carrying a reasonable volume of ink in the ink cartridge on the carriage has become impractical. If a small volume of ink is carried to reduce weight and momentum of the carriage, frequent change is necessary as the ink supply is rapidly diminished. Alternatively, carrying a large volume of ink in the cartridge makes the cartridge large and heavy, neither of which is desirable for a fast moving carriage.

To satisfy the goal of reducing carriage weight, and to provide adequate ink volumes for printers requiring such, it has been known to provide large volume, off carriage ink reservoirs. A flexible tube connects the ink reservoir to the ink cartridge on the carriage, and only a small amount of ink needs be carried within the cartridge itself.

However, the use of off-carriage ink reservoirs presents its own unique set of problems. It is most often necessary to operate an off carriage ink delivery system at a slight negative or back pressure, to prevent ink dripping from the nozzles. However, back pressure that is too high can result in the printhead becoming deprimed, creating additional printing problems. Further, high back pressure can draw air into the ink supply system, which then can become trapped within the ink, causing even further printing problems.

Additionally, when an emptied ink reservoir is removed from the system and replaced with a fill ink reservoir, air can be introduced into the ink delivery tubing. The trapped air will eventually enter the cartridge or accumulate in a critical location and an accumulation of air in the cartridge or critical location can prematurely end the life of a cartridge by starving the printhead for ink.

What is needed is an ink delivery system that overcomes the aforementioned problems by providing for air removal in the system while simultaneously providing ink to a printhead.

### BRIEF SUMMARY OF THE INVENTION

According to one embodiment of the invention, there is disclosed an ink delivery system. The system includes an ink container, operable to interface with and provide ink to a printhead, where the ink container and the printhead are positioned on a moveable carriage. The system also includes an ink supply item, operable to transmit ink to the ink container via an ink conduit, and a vacuum source, coupled to an upper portion of the ink container via an air conduit, where the vacuum source is operable to pull air from the ink container by generating negative pressure in the ink container.

According to one aspect of the invention, the vacuum source is a low pressure pump. The vacuum source can also be a diaphragm pump. According to another aspect of the invention, the ink container further includes a screen operable to interface with a felt of the printhead. According to yet another aspect of the invention, the screen is operable to prevent air from entering the ink container from the printhead. Furthermore, the ink container can include a filter operable to filter the air pulled from the ink container by the vacuum pump. The filter may be a hydrophobic material, and can prevent ink from entering the air conduit.

According to another embodiment of the invention, there is disclosed a method of controlling ink flow in an ink jet printer. The method includes providing an ink container, where the ink container supplies ink to a printhead, and pumping air from the ink container using a vacuum pump, where the vacuum pump is operable to remove air from an upper portion of the ink container. The method also includes automatically supplying ink to the ink container upon the generation of negative pressure in the ink container resulting from the pumping of air from the ink container by the vacuum pump.

According to one aspect of the invention, the method includes supplying ink to the ink container from an ink supply item coupled to the ink container via an ink conduit. According to another aspect, the ink container supplies ink to the printhead via at least one screen that interfaces with a felt of the printhead. The method can also include maintaining pressure in the ink container such that the at least one screen maintains contact with ink within the printhead.

According to yet another aspect of the invention, the vacuum pump is operable to remove air from an upper portion of the ink container via at least one filter. The at least one filter can include a hydrophobic material. Additionally, the ink container can be operable to supply ink to the printhead via at least one screen that interfaces with the printhead. According to another embodiment, air may be pumped from the ink container using a diaphragm pump.

According to yet another embodiment, there is disclosed an ink container for use in an ink delivery system. The ink container includes at least one ink reservoir operable to receive ink from an ink supply item via an ink conduit, a common air chamber, open to the at least one ink reservoir, and an air removal opening for interfacing with the common air chamber. Additionally, the air removal opening is operable to expel air from the at least one ink reservoir resulting from negative pressure in the common air chamber.

According to one aspect of the invention, the ink container also includes an air drain positioned in between the common air chamber and the at least one ink reservoir. The air drain may also include a filter operable to cover the air drain. According to another aspect of the invention, the ink container can include at least one film operable to seal the common air chamber.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an ink delivery system, according to an illustrative embodiment of the present invention.

FIG. 2 is a perspective view of an ink container, according to an illustrative embodiment of the present invention.

FIG. 3 is a rear view of the ink container of FIG. 2, according to an illustrative aspect of the present invention.

FIG. 4 is an exploded view of the ink container of FIG. 2, showing ink film, screens and filters, according to an illustrative embodiment of the present invention.

FIG. 5 is a block diagram flow chart illustrating an air removal, according to an embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

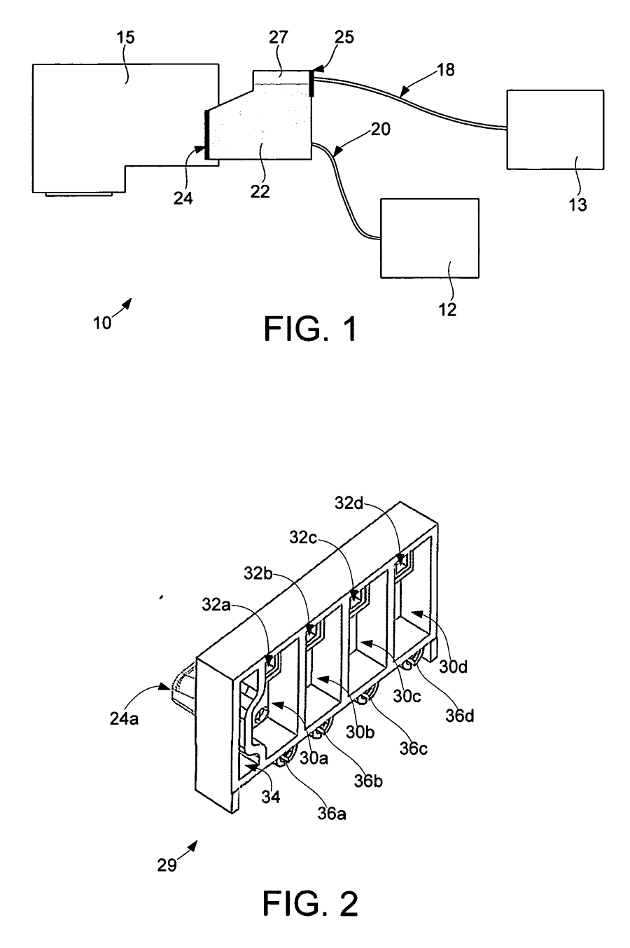

FIG. 1 shows an ink delivery system 10 according to an illustrative embodiment of the present invention. The ink delivery system 10 can be used in an ink jet printer, plotter, fax machine or the like, and is particularly useful in a high speed, high volume printing application. The ink delivery system 10 includes an ink supply item 12 and an ink container 22 that provide ink to a printhead 15. The ink supply item 12 is remote from the ink container 22, and an ink conduit 20, such as flexible tubing or the like, interconnects ink supply item 12 and ink container 22 such that ink contained in ink supply item 12 can be transmitted to ink container 22.

The ink container 22 is normally carried on a carriage that traverses back and forth in close proximity to the media upon which the printed image is being formed. The ink container 22 engages the printhead 15, which has an array of nozzles (not shown) from which ink droplets are emitted in the desired pattern and sequence for creating the desired image on the media intended to receive the printed image. As described in greater detail with respect to FIG. 2, the ink container 22 includes one or more ink reservoirs, and ink ducts, channels, vias and the like (not shown) by which ink is supplied to the printhead 15 for emission onto a printing surface. Ink droplet generators, such as piezo elements, heaters or the like are also provided. According to one aspect of the invention, the printhead 15 is a vented printhead that includes an ink refill opening to allow the printhead 15 to be semi-permanent in the ink delivery system 10. The structure and operation of a printhead 15 and the carriage on which the ink container 22 is mounted are well known to those skilled in the art and will not be described in further detail herein.

It will be appreciated that the ink supply item 12 includes a housing that encloses an ink reservoir (not illustrated), which may be a flexible bladder or the like, as those skilled in the art will readily understand. The ink supply item 12 may also include an outlet (not illustrated) that connects to the ink conduit 20. According to one aspect of the invention, the ink supply item 12 is mounted in a stationary manner in the printing device, and remains in place even as the carriage carrying ink container 22 traverses back and forth during a printing operation. Thus, the ink supply item 12 may be off carriage, as opposed to the ink container 22 and printhead 15, which may be both on carriage. The ink conduit 20 is sufficiently long and flexible to move as required, to maintain fluid flow communication between ink container 22 and ink supply item 12, even as the ink container 22 is moved during printing. According to another embodiment of the present invention, the ink supply item 12 may also be carried on the carriage such that it is on carriage.

As is shown in FIG. 1, the ink delivery system 10 includes a vacuum source 13 that is coupled to an air conduit 18, which in turn is connected to an upper portion 27 of the ink container 22. A filter 25 is provided at the interface of the air conduit 18 and the upper portion 27 of the ink container 22. The ink within the ink container 22 is illustrated in FIG. 1 by the shaded region, such that the ink does not fill the ink container 22 fully. That is, the ink does not fill up the entire upper portion 27 of the ink container. Air adjacent the air conduit 18 and the filter 25 can be removed. According to one aspect of the invention, the vacuum source 13 is a vacuum pump, and removes air from the upper portion 27 of the ink container 22 via the air conduit 18, which may include flexible tubing or the like. The vacuum source 13 can also include a pressure relief valve to maintain acceptable pressure levels in the air conduit and in the upper portion 27 of the ink container 22. The vacuum source can also include a check valve that prevents air from returning to the ink container 22. Both the pressure relief and check valve can be separate from the pump. According to one aspect of the invention, the pump 13 may be a low pressure diaphragm vacuum pump to keep the filter 25 from being damaged.

The filter 25 provided at the interface of the air conduit and the air removal portion 27 of the ink container 22 is operable to allow air to enter the air conduit 18 while preventing ink from entering the air conduit 18. According to one aspect of the invention, the filter is constructed of a hydrophobic mesh material, such as porous treated polysulphone, treated acrylic copolymers, porous polytetrafluoroethylene, or other treated polymers. Various hydrophobic materials are available from sources such as Pall Corp or Gore Corp. A suitable hydrophobic material for the filter 25 does not wet easily, and therefore retains a no-liquid pass property even as the material is contacted by ink from within the ink container 22. This property can be significant as the ink level within the ink container 22 may rise to the level of the filter 25 during operation of the ink delivery system 10. It will be appreciated that while only a single filter 25 is illustrated in the side view of the ink delivery system 10 shown in FIG. 1, several filters 25 may be used. For instance, a filter may exist for each color ink stored in individual reservoirs within the ink container, as will be described in greater detail with respect to FIG. 2.

Referring again to FIG. 1, the ink container 22 also includes at least one screen 24 at a ink supply interface with the printhead 15. Like the filter 25, several screens may exist and may each correspond to an ink reservoir within the ink container; however, only a single screen is illustrated in FIG. 1. Thus, for simplicity, the screen 24 shown in FIG. 1 may represent a screen corresponding to a single ink color and ink reservoir within the ink container 22. The screen 24 is in contact with a wetted portion of the felt or foam. The screen 24 then functions as an air check to minimize air from entering the ink container 22 from the printhead 15 while permitting ink to flow in both directions between the ink container 22 and the printhead 15. According to an aspect of the invention, the screen is a low resistance interface with the printhead 15, and interfaces with a felt within the printhead 15. According to another aspect of the present invention, the screen 24 may be a hydrophilic mesh screen, such as a stainless steel filter screen commonly used in ink jet cartridges. Typically a vented printhead would be used in this case although with proper seals around the screen/felt connection a non-vented printhead could be used. According to one aspect of the invention, an alternate connection to the screen/felt connection with the printhead can include a needle/septum connection between the ink container and printhead. In this case a non-vented printhead would typically be used. In either case air is still removed from the ink container. As used herein, the term needle/septum connection means that one part has a male projection such as a needle and the other part has a female mating component such as a septum.

Because the ink supply item 12 is positioned at a lower height than the ink container 22 in the ink delivery system 10, the screen's 24 ability to prevent air from entering the ink container 22 prevents the ink within the ink container from draining back into the ink supply item 12. Additionally, it will be appreciated that air is accumulated within the ink container 22 away from the screen 24 to prevent high pressure from developing at the ink supply interface with the printhead 15, which could prevent the printhead 15 from being resupplied with ink.

As described above, the printhead 15 may be a vented printhead, and the ink required for operation will be provided directly from the felt, which receives the ink from the ink container 22. The felt in the printhead 15 can also include and/or be replaced by foam or fibrous materials. Ink used from the felt creates the pressure demand for ink replenishment. A non-vented printhead can have a flexible member to replace the capacitance function of the felt. Additionally, the removal of air from the ink container 22 supply subsystem so that ink is always against the screen, or supplied to the printhead keeping the pressure drop low. With this air removal configuration the ink delivery system 10 can be shipped dry and then primed with ink during a machine initialization process. The air removal stops when ink is against filter 25, at this time the vacuum system only exerts pressure on the filter 25 and no longer on the ink container 22.

It will be appreciated by one of ordinary skill in the art that the height of ink in the off-carriage ink supply item 12 and the backpressure of ink in the felt of a vented printhead 15 are in equilibrium in the ink delivery system 10. Ink flows in or out of the printhead 15 to maintain this equilibrium. As an illustrative example, with all backpressures measured relative to the nozzle plate, if under normal conditions the ink supply item 12 ink fluid height is 4 cm below the printhead chip, then the printhead backpressure will be −4 cmH₂O when equilibrium exists. Continuing with this illustrative example, if the printhead backpressure increases to −5 cmH₂O then a 1 cmH₂O pressure draw to resupply ink to the printhead 15 is created. Ink will continue to flow until this differential is eliminated. The higher the backpressure difference the faster the ink is replenished to the printhead 15.

It will also be appreciated that during normal printing operations ink is supplied by the printhead 15. In the short term the ink is replaced by a combination of ink coming from the ink container 22 and air coming in through a vent in the printhead 15. As air comes into the printhead 15 the backpressure increases and pulls ink through the ink supply path until the air is replaced with ink. The printing and ink resupply system (which includes the ink container 22, ink conduit 20, and ink supply item 12) act asynchronously. The printhead 15 supplies peak flow requirements while the resupply subsystem replenishes ink at a delayed and normally slower rate. Instead of pulling air into the printhead 15 a non-vented printhead supplies part of the ink by changing volume. The volume change increases backpressure and will decrease and reach equilibrium when the ink is re-supplied and the volume returns to normal. A non-vented printhead system without volumetric changes requires all the demand volume to come from outside of the printhead.

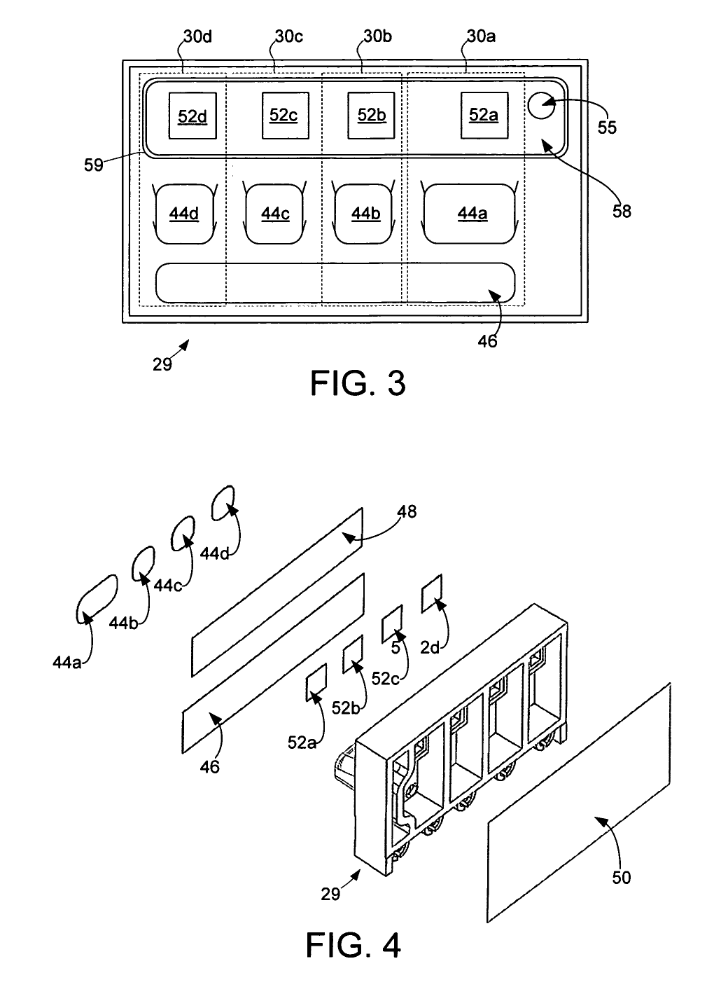

FIG. 2 shows a perspective view of an illustrative embodiment of an ink container 29 of the present invention. According to one aspect of the invention, the ink container 29 may be molded from plastic, such as by injection molding, and film may be later added to seal off chambers and channels, as is described below with respect to FIGS. 3 and 4. The ink container 29 shown in FIG. 2 includes four ink reservoirs 30a, 30b, 30c, 30d that receive ink via four respective ink conduits (not illustrated). The ink reservoirs 30a, 30b, 30c, 30d can each represent a different color ink used by the printhead 15. The ink conduits supply ink to the ink container from respective ink supply items, or from a single ink supply item having individual reservoirs for each ink color. The ink conduits that provide the ink to the ink reservoirs 30a, 30b, 30c, 30d feed the ink into the reservoirs via ink conduit receptacles 36a, 36b, 36c, 36d associated with each ink reservoir 30a, 30b, 30c, 30d. Each ink reservoir, in turn, provides ink to the printhead 15 via a corresponding ink supply projection, on which respective screens, as described above, are placed. A single ink supply projection 24a corresponding to the leftmost ink reservoir 30a of FIG. 2 is illustrated in the perspective view of FIG. 2. It will be appreciated that the ink container 29 of FIG. 2 is illustrative, and that only one, or a greater number of ink reservoirs may be utilized according to the present invention.

In this design an extra chamber is used to remove air from the system. Therefore, an air receptacle 34 is positioned in the ink container 29, which receives an air conduit (not illustrated) that pumps air out of the ink container 29. The air conduit may be received into a conduit receptacle within or connected to the air receptacle similar to the ink conduit receptacles 36a, 36b, 36c, 36d. As described in detail below, the air receptacle 34 includes an air removal opening in the ink container 29 that receives air from each of the ink reservoirs 30a, 30b, 30c, 30d, specifically, from air drains 32a, 32b, 32c, 32d that are integrated into the ink container 29.

Each air drain 32a, 32b, 32c, 32d is exposed to, or open to, an associated ink reservoir and permits air from the ink reservoir to flow through a respective filter (not illustrated) to the air conduit (not illustrated) via the air receptacle 34. According to one aspect of the invention, the air drains 32a, 32b, 32c, 32d may be covered by one or more filters that prevent the flow of ink within the ink reservoirs 30a, 30b, 30c, 30d into the air conduit. The back side of the ink container 29 of FIG. 2 is shown in FIG. 3. The air drains 32a, 32b, 32c, 32d are open to a common air chamber 58 on the back of the ink container 29. Additionally, the one or more filters 52a, 52b, 52c, 52d are disposed on the back side of the air drains 32a, 32b, 32c, 32d such that air passes through the filters 52a, 52b, 52c, 52d and into the common air chamber 58. Air leaves the common air chamber 58 via an air removal opening 55 and the air receptacle 34, through which air flows into the air conduit. As described with respect to FIG. 1, the air conduit, in turn, is connected to the pump 13, which pulls air from the ink container 29, and more specifically, from each ink reservoir via the common air chamber 58.

As shown in FIG. 3, the filters 52a, 52b, 52c, 52d are attached to the ink container 29 on the back side, or rear, of the ink container directly opposite the air drains 32a, 32b, 32c, 32d. Although illustrated as separate items, the filters may include a single piece of material that extends across all of the rear sides of the air drains 32a, 32b, 32c, 32d. According to another aspect of the invention, the filters 52a, 52b, 52c, 52d may also be attached to the ink container 29 on the inside of the individual ink reservoirs 30a, 30b, 30c, 30d, and more specifically, in or covering the air drains 32a, 32b, 32c, 32d.

For illustrative purposes, the general location of the ink reservoirs 30a, 30b, 30c, 30d are illustrated with dashed lines in FIG. 3, which also illustrates that the common air chamber 58 extends across all of the air drains 32a, 32b, 32c, 32d and filters 52a, 52b, 52c, 52d. Additionally, FIG. 3 illustrates the ink supply projections corresponding to each ink reservoir 30a, 30b, 30c, 30d, each ink supply projection having a screen 44a, 44b, 44c, 44d thereon for interfacing with the printhead 15, as was described above with respect to FIG. 1. As is also illustrated in FIG. 1 and FIG. 3, the ink supply projections are generally angled downward to facilitate the flow of air toward the upper portion 27 of the ink container 29. As stated earlier the screen interface to the printhead can be replaced, as appropriate, with a needle/septum interface.

FIG. 4 shows an exploded view of film used to enclose chambers of the illustrative ink container 29 described with respect to FIGS. 2 and 3. It will be appreciated that each of the openings and channels in the ink container 29 may be sealed using film. According to another embodiment, welded plates may replace the film. Thus, the common air chamber is created by covering the chamber with vacuum film 48, which seals the air chamber so that air can be removed from the common air chamber 58 by the pump. It will therefore be appreciated that the ink container 29 is molded with a wall 59 (or perimeter) that extends outwardly to receive the vacuum film 48 and to enclose the filters 52a, 52b, 52c, 52d. Similar walls exist to receive the ink film 46 which completes passages opposite the ink conduit receptacles 36a, 36b, 36c, 36d, and the air receptacle 34 and ink reservoirs 30a, 30b, 30c, 30d. The body film 50 completes the air receptacle 34 and ink reservoirs 30a, 30b, 30c, 30d.

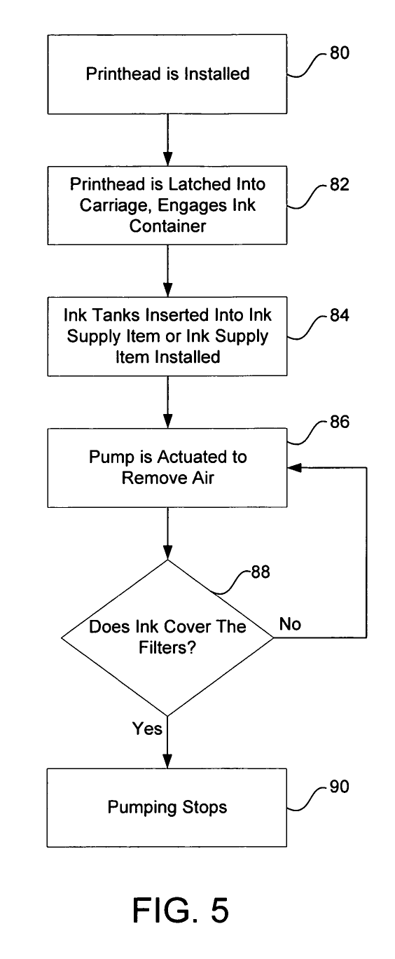

FIG. 5 is a block diagram flow chart illustrating the process that occurs during printer setup or during periodic air removal in a printer having an ink delivery system of the present invention. During initial setup, a semi-permanent printhead having a vent is installed (block 80). The printhead is latched into the carriage (block 82), which causes the printhead to engage the ink container, and more particularly, causes the felt of the printhead to engage one or more screens at the ink supply interface with the printhead. In like manner a non-vented printhead could have the needles and septums engaged. Ink tanks may then be inserted into the ink supply item and/or the ink supply item may be inserted (block 84). After the components are installed, a cover may be closed and the pump is actuated to remove air from the ink container (block 86).

It will be appreciated that ink from the printhead will wet the one or more screens such that a large quantity of air will not be pulled into the ink container from the printhead. Thus, the pump, which may be a low pressure vacuum pump, is actuated as many times as required (blocks 86, 88) to remove the air from the ink container and replace it with ink. This ink comes primarily from the ink supply item although initially a small amount comes from the printhead. Air stops being removed from the system when ink covers the filters (block 90). Additional pump actuation does nothing to the system since the pressure generated is limited so ink is not pulled through the filters. To achieve backpressure equilibrium between the printhead and off carrier ink source, ink may either come into or leave the printhead. Periodic actuation of the pump can remove any air that may accumulate over time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An ink delivery system, comprising:
an ink container, operable to interface with and provide ink to a printhead, wherein the ink container and the printhead are positioned on a moveable carriage;
an ink supply item, operable to transmit ink to the ink container via an ink conduit; and
a vacuum source, operably coupled to an upper portion of the ink container, wherein the vacuum source is operable to pull air from the ink container by generating negative pressure in the ink container.

2. The ink delivery system of claim 1, wherein the vacuum source comprises a low pressure pump.

3. The ink delivery system of claim 1, wherein the vacuum source comprises a diaphragm pump.

4. The ink delivery system of claim 1, wherein the ink container further comprises a screen, wherein the screen is operable to interface with a felt of the printhead.

5. The ink delivery system of claim 4, wherein the screen is operable to prevent air from entering the ink container from the printhead.

6. The ink delivery system of claim 1, wherein the ink container further comprises at least one of a projection and a receiving member, the at least one of a projection and a receiving member being operable with a corresponding receiving member or projection on the printhead.

7. The ink delivery system of claim 1, wherein the ink container further comprises a filter, wherein the filter is operable to filter the air pulled from the ink container by the vacuum source.

8. The ink delivery system of claim 7, wherein the filter comprises a hydrophobic material.

9. The ink delivery system of claim 7, wherein the filter is operable to prevent ink from entering the air conduit.

10. The vacuum source of claim 1, wherein the vacuum source has a pressure relief valve to limit the vacuum pressure.

11. A method of controlling ink flow in an ink jet printer, comprising:
providing an ink container, wherein the ink container supplies ink to a printhead;
pumping air from the ink container using a vacuum source, wherein the vacuum source is operable to remove air from an upper portion of the ink container, and
automatically supplying ink to the ink container upon the generation of negative pressure in the ink container resulting from the pumping of air from the ink container by the vacuum source.

12. The method of claim 11, further comprising supplying ink to the ink container from an ink supply item operably coupled to the ink container via an ink conduit.

13. The method of claim 11, wherein providing an ink container further comprises providing an ink container, and wherein the ink container supplies ink to the printhead via at least one screen that interfaces with a felt of the printhead.

14. The method of claim 13, further comprising maintaining pressure in the ink container such that the at least one screen maintains contact with ink within the vented printhead.

15. The method of claim 11, wherein the ink container supplies ink to the printhead via at least one of a projection and a receiving member that interfaces with a corresponding receiving member or projection of the printhead.

16. The method of claim 11, wherein pumping air from the ink container comprises pumping air from the ink container using a vacuum pump, wherein the vacuum pump is operable to remove air from an upper portion of the ink container via at least one filter.

17. The method of claim 15, wherein providing an ink container comprises providing an ink container operable to supply ink to the printhead via at least one of a projection or a projection receiving member that interfaces with the printhead.

18. An ink container for use in an ink delivery system, comprising:
at least one ink reservoir, wherein the at least one ink reservoir is operable to receive ink from an ink supply item via an ink conduit;
a common air chamber, open to the at least one ink reservoir; and
an air removal opening, for interfacing with the common air chamber,
wherein the air removal opening is operable to expel air from the at least one ink reservoir resulting from negative pressure in the common air chamber.

19. The ink container of claim 18, further comprising an air drain positioned in between the common air chamber and the at least one ink reservoir.

20. The ink container of claim 19, further comprising a filter, wherein the filter is operable to cover the air drain.

21. The ink container of claim 18, further comprising at least one film, wherein the at least one film is operable to seal at least one of the common air chamber, an air chamber and an air removal path.
